(19) United States
(12) Patent Application Publication
(10) Pub. No.: US 2005/0049328 A1
(43) Pub. Date: Mar. 3, 2005

(54) Surface film with depositing function, the production and use thereof

(76) Inventors: Peter Schmiedel, Duesseldorf (DE); Axel Becker, Pfungstadt (DE); Annett Lossack, Duesseldorf (DE); Andreas Ferencz, Duesseldorf (DE); Elke Scholl, Willich (DE)

Correspondence Address: HENKEL CORPORATION, THE TRIAD, SUITE 200, 2200 RENAISSANCE BLVD., GULPH MILLS, PA, 19406, US

(21) Appl. No.: 10/487,288

(22) PCT Filed: Aug. 13, 2002
(86) PCT No.: PCT/EP02/09041

(30) Foreign Application Priority Data
Aug. 22, 2001 (DE) 101 41 089.1

(51) Int. Cl. C09D 11/26; C08H 1/00

(52) U.S. Cl. 523/218; 106/122

(57) ABSTRACT

The invention relates to a composition, comprising at least water, a porous particulate polymer, or a mixture of two or more such polymers and at least one water-soluble or water-dispersible hydrophilic compound with a molecular weight of less than 1000, or a mixture of two or more thereof.

The present invention relates to a composition, at least comprising water, a porous particulate polymer, or a mixture of two or more such polymers, and at least one water-soluble or water-dispersible hydrophilic compound with a molecular weight below 1000, or a mixture composed of two or more of these.

In domestic or industrial surroundings, a wide variety of soiling occurs on surfaces of articles, and on walls, ceilings or floors of rooms, and also on mobile or stationary outdoor articles, such as automobiles, construction machinery, traffic signs, garden furniture, and the like. The cleaning of this soiling from the surfaces mentioned is often time-consuming and difficult. The prior art comprises various surface coatings that are proposed in order to make this task easier and that adhere permanently onto the corresponding surfaces and are intended to make them easier to clean. Among these, by way of example, are silicone coatings. However, a disadvantage with these coatings is that they cannot generally be applied by the actual user and moreover have a rather adverse effect particularly in relation to soiling with grease, because the coating is associated with hydrophobicization of the surface.

JP-A 2000-265163 discloses articles with hydrophilicized surface whose external surface comprises a surfactant or a hydrophilic substance in combination with an applied fixed substance which undergoes delayed release in water. However, the articles described in that specification have to have a finely roughened surface structure in order to exert the described advantageous effect in relation to water vapor condensation. Furthermore, the coatings described in that specification can give only slightly hydrophilicized surfaces, as can be discerned from the contact angle of 40° with respect to water.

The solution known from the prior art therefore has various disadvantages which make it difficult to apply the technique which it describes. By way of example, an article to be provided with the coatings which it describes first recquires complicated treatment to give it a roughened surface, in order to obtain an ideal effect from the coating. However, this in principle prevents this type of protective coating from being applied by the user to all of the articles that the user desires. The user is therefore always tied to a particular product pretreated for a roughened surface. In addition, even when the coatings described in the prior art are used, the surfaces obtained are only slightly hydrophilicized and moreover do not provide adequate protection in terms of a favorable effect against the soiling which, by way of example, occurs in bathrooms or in shower cubicles, or in similar rooms that are frequently exposed to splashing with water.

An object underlying the present invention was therefore to provide compositions and processes for their preparation which do not have the above-mentioned disadvantages known from the prior art. A particular object underlying the present invention was to provide a composition which can be applied by the user in a simple manner to any desired surfaces and articles, and becomes effective on these. Another object underlying the present invention was to provide a composition which is present in the form of a substantially transparent film on a surface and does not alter the external appearance of the surface, or alters it only insignificantly. Another object underlying the present invention was to provide a composition which has been bonded semipermanently to a surface and withstands more than one soiling cycle without significant impairment of its effectiveness.

The abovementioned objects are achieved by way of a composition as described within the text below.

The present invention provides a composition, at least comprising water, a porous particulate polymer, or a mixture of two or more such polymers, and at least one water-soluble or water-dispersible hydrophilic compound with a molecular weight below 1000, or a mixture composed of two or more of these, where the median particle size of the polymer is from 1 nm to 50 μm, and the water-solubility of the polymer is below 2 g/l at a temperature below 40° C. at a pH of from 5 to 8, in particular from about 5.5 to about 7.

For the purposes of the present invention, a “polymer” is a compound whose molecular weight is above 1000 and whose polymer backbone has at least one structural unit that repeats at least once.

For the purposes of the present invention, the term “porous” means a condition in which a polymer particle does not have a shell which is sealed with respect to the environment of the particle and which is not penetrable by substances present in the environment of the polymers or by substances present in the interior of the polymer particle. A polymer particle termed “porous” for the purposes of the present invention does not in principle have to be present in a porous condition, but there has to be at least one existing environment in which the polymer particle can be termed “porous” in the sense of the above definition. For the purposes of one preferred embodiment of the present invention, a “porous” polymer has pores in an aqueous environment, i.e. in an environment comprising water. By way of example, a polymer is termed “porous” in the inventive sense if it swells in an appropriate, preferably aqueous environment, the interior of the polymer particle thus becoming accessible after the swelling process.

For the purposes of the present invention, the term “particulate” refers to the condition of the polymer present in an inventive composition. A “particulate” polymer here is a polymer present in the form of discrete particles separately dispersed or colloidally dispersed in an aqueous environment. It is of no significance here whether the polymer is present as particle agglomerates or in the form of its primary particles in the selected solvent. “Primary particles” here means particles which can be separated only by breaking up the polymer to give the individual polymer molecules. “Agglomerates”, in contrast, are primary particles adhering to one another with some degree of looseness, these being capable of breakdown into the primary particles by suitable measures, such as ultrasound treatment and the like.

For the purposes of the present invention, a particulate polymer is solid at least at the microscopic level, and this means that an individual polymer particle cannot flow. However, this does not exclude the possibility that an accumulation of such polymer particles, for example an accumulation which may occur in a polymer film, may sometimes have slight flowability at room temperature.

For the purposes of the present invention, a “particulate polymer” has a diameter below about 100 μm, for example below 50 μm, below 30 μm, or below 10 μm. For the purposes of one preferred embodiment of the present invention, at least about 95% of the polymer particles which may be used according to the invention have a diameter below about 30 μm, for example below about 10 μm, or below 3 μm. The stated diameters here refer to the values measured for particle diameter and obtainable by means of conventional methods for the determination of particle diameters. By way of example, suitable measurement methods are sieve methods, laser scattering, electron microscopy, or sedimentation methods. The accretion of two or more polymer particles to form an aggregate is permitted by this definition. The decisive factor in this instance is the particle size of the individual particles involved in the aggregate. For the purposes of the present text, the “median particle diameter” is the values usually termed d50 or x50, where 50% of the particles have a diameter greater than the stated median particle diameter and 50% of the particles have a diameter smaller than the stated median particle diameter.

For the purposes of the present invention, suitable polymers are in principle any of the porous, particulate polymers whose water-solubility is below 2 g/l at a temperature of below 40° C. at a pH of from 5 to 8, in particular from about 5.5 to about 7.

An inventive composition preferably comprises porous, particulate polymers whose solubility in water is below about 0.5 or about 0.1 g/l at a temperature below 40° C. at a pH of from 5 to 7.

By way of example here, a polymer which may be used for the purposes of the present invention may be water-soluble as a consequence of its underlying chemical structure but inhibited from solvation by crosslinking.

For the purposes of the present invention, it is equally possible to use polymers which are in principle water-soluble but, by way of example, are insoluble at a pH that lies within the abovementioned range.

By way of example, therefore, polymers which may be used for the purposes of the present invention comprise natural or synthetic polymers which meet the abovementioned conditions.

Examples of suitable polymers are those which form hydrogels in an aqueous environment. Particularly suitable polymers here are those which exhibit crosslinking, such as covalent crosslinking or crosslinking due to ionic interactions.

Examples of suitable natural polymers are polysaccharides, such as alginates, guar, xanthan, carrageenan, cellulose ethers, such as methylcellulose, hydroxyethylcellulose, ethylcellulose, hydroxypropyl-cellulose, hydroxypropylmethylcellulose, or carboxymethylcellulose, starch derivatives, or proteins. The conditions previously stated above apply to the water-solubility of the abovementioned natural polymers. If the natural polymers mentioned do not comply with the criteria for their water-solubility, they may be adjusted to appropriate water-solubility, for example via suitable derivatization, in particular via crosslinking by suitable crosslinking agents.

Examples of suitable synthetic polymers are polyacrylates, polymethacrylates, polyacrylamides, polymethacrylamides, polyurethanes, polyesters, polyamides, polyvinylpyrrolidones, vinyl polymers, such as polyvinyl acetate, polyvinyl alcohols, and also copolymers composed of two or more of the abovementioned types of polymer.

Examples of suitable crosslinking agents are formaldehyde, epichlorohydrin, glyoxal, phosphorus oxichloride, condensates of formaldehyde and urea, thiourea, guanidine, melamine, dimethylolurea, dimethylolethyleneurea, diepoxides, diimines, diaziridines, dicyclopropanes, dilactones, dilactams, diisocyanates, diacetals, diketenes, dialdehydes, dicarboxylic acids, diacid chlorides, anhydrides, di(ortho) esters, dihalides, divinyl compounds, divinyl sulfones, or dialkyl sulfones, or mixtures composed of two or more of these.

By way of example, a porous polymer particle suitable according to the invention includes at least one polymer based on at least one monoethylenically unsaturated monomer having an acid group. Some or all of the acid groups of the monomer used may have been neutralized.

Suitable monoethylenically unsaturated monomers having an acid group are acrylic acid, methacrylic acid, ethacrylic acid, α-chloroacrylic acid, β-cyanoacrylic acid, β-methylacrylic acid (crotonic acid), α-phenylacrylic acid, β-acryloxypropionic acid, sorbic acid, α-chlorosorbic acid, 2′-methylisocrotonic acid, cinnamic acid, p-chlorocinnamic acid, β-stearyl acid, itaconic acid, citraconic acid, mesaconic acid, glutaconic acid, aconitic acid, maleic acid, fumaric acid, tricarboxyethylene, and maleic anhydride, hydroxyl- or amino-containing esters of the above acids, preferably of acrylic or methacrylic acid, e.g. 2-hydroxyethyl acrylate, N,N-dimethylaminoethyl acrylate, and also the analogous derivatives of methacrylic acid, particularly suitable compounds being acrylic acid and methacrylic acid.

A suitable polymer particle for the purposes of the present invention for use in an inventive composition may be based not only on the monoethylenically unsaturated monomers having an acid group but also on comonomers other than the monoethylenically unsaturated monomer having an acid group. By way of example, suitable comonomers are ethylenically unsaturated sulfonic acid monomers, ethylenically unsaturated phosphonic acid monomers, or acrylamides, or mixtures composed of two or more of these.

By way of example, ethylenically unsaturated sulfonic acid monomers are aliphatic or aromatic vinylsulfonic acids or acrylic or methacrylic derivatives of sulfonic acids. By way of example, aliphatic or aromatic vinylsulfonic acids are vinylsulfonic acid, allylsulfonic acid, 4-vinylbenzylsulfonic acid, vinyltoluenesulfonic acid, or styrenesulfonic acid, or mixtures composed of two or more of these. Examples of suitable acrylic or methacrylic derivatives of sulfonic acids are sulfoethyl acrylate, sulfoethyl methacrylate, sulfopropyl acrylate, sulfopropyl methacrylate, 2-hydroxy-3-methacryloxypropylsulfonic acid, and 2-acrylamido-2-methylpropanesulfonic acid.

Examples of olefinically unsaturated phosphonic acid monomers are vinylphosphonic acid, allylphosphonic acid, vinylbenzylphosphonic acid, acrylamido-alkylphosphonic acids, acrylamidoalkyldiphosphonic acids, phosponomethylated vinylamines, or (meth)acrylic derivatives of a phosphonic acid.

Examples of acrylamides are alkyl-substituted acrylamides, or aminoalkyl-substituted derivatives of acrylamide or of methacrylamide, e.g. N-vinylamides, N-vinylformamides, N-vinylacetamides, N-vinyl-N-methylacetamides, N-vinyl-N-methylformamides, N-methylol(meth)acrylamides, vinylpyrrolidone, N,N-dimethylpropylacrylamide, dimethylacrylamide, or diethylacrylamide, or the corresponding methacrylamide derivatives, or acrylamide, or methacrylamide, or mixtures composed of two or more of these.

Other comonomers which may be used are monomers with very low solubility in water. The amount of these comonomers should be in the range from about 0.01 to about 20% by weight, for example from about 0.1 to about 15% by weight, or from about 0.5 to about 5% by weight, based on the entirety of monomers used. Examples of these monomers are acrylic and methacrylic esters, such as ethyl acrylate and methacrylic acrylate, butyl acrylate and butyl methacrylate, vinyl acetate, styrene, or isobutylene, or mixtures composed of two or more of these.

All of the acids listed may be polymerized as free acids or as salts during the preparation of the porous polymer particles which may be used according to the invention. Partial neutralization is also possible. Complete or partial neutralization may also have taken place after the polymerization. The neutralization of the monomers may have used alkali metal hydroxides, alkaline earth metal hydroxides, ammonia, or else carbonates or bicarbonates or mixtures composed of two or more of these. Besides these, any other base which forms a salt with the acid to be neutralized is in principle suitable. Mixed neutralization, using different bases, is also possible.

Various polymerization methods may be used to prepare, from the abovementioned monomers, a polymer particle which may be used for the purposes of the present invention. By way of example, mention may be made in this context of solution polymerization, spray polymerization, emulsion polymerization, and suspension polymerization.

Various parameters known to the person skilled in the art may be varied during preparation of the polymer so that the resultant polymers have the above-mentioned properties in relation to their water-solubility and their particle size. By way of example, therefore, the monomer composition of copolymers may be adjusted so that their water-solubility is within the abovementioned limits. Suitable monomer combinations are known to the person skilled in the art. By way of example, it is moreover possible to adjust the particle size of the polymer particles by controlling the polymerization parameters, for example emulsifier amount or emulsifier type or stirrer speed during the emulsion polymerization process.

By way of example, another way of controlling the water-solubility of the polymer particles which may be used according to the invention is crosslinking. A polymer particle which may be used for the purposes of the present invention may, by way of example, have been crosslinked by a chemical crosslinking agent, or by thermal crosslinking, or radiation crosslinking, or by two or more of the methods mentioned, preference being given to crosslinking by a chemical crosslinking agent.

Chemical crosslinking is achieved by the crosslinking agents well-known to the person skilled in the art. The preferred amount of these crosslinking agents during the preparation of the polymer particles which may be used according to the invention is below 7% by weight, preferably from 0.1 to 5% by weight, based on the total weight of the monomers used. Crosslinking agents suitable according to the invention are polyacrylic or polymethacrylic esters, which are obtained, by way of example, by reacting a polyol or ethoxylated polyol, such as ethylene glycol, propylene glycol, trimethylolpropane, 1,6-hexanediol, glycerol, pentaerythritol, polyethylene glycol, or polypropylene glycol, with acrylic acid or methacrylic acid.

Other crosslinking agents which may be used are polyols, amino alcohols, and their mono(meth)acrylic esters, and monoallyl ethers. Other suitable crosslinking agents are acrylic esters of the monoallyl compounds of the polyols and amino alcohols.

Another group of suitable crosslinking agents is obtained by reacting polyalkylene polyamines, such as diethylenetriamine, and triethylenetetraminemethacrylic acid or methacrylic acid.

Examples of suitable crosslinking agents are 1,4-butanediol diacrylate, 1,4-butanediol dimethacrylate, 1,3-butylene glycol diacrylate, 1,3-butylene glycol dimethacrylate, diethylene glycol diacrylate, diethylene glycol dimethacrylate, ethoxylated bisphenol A diacrylate, ethoxylated bisphenol A dimethacrylate, ethylene glycol dimethacrylate, 1,6-hexanediol diacrylate, 1,6-hexanediol dimethacrylate, neopentyl glycol dimethacrylate, polyethylene glycol diacrylate, polyethylene glycol dimethacrylate, triethylene glycol diacrylate, triethylene glycol dimethacrylate, tripropylene glycol diacrylate, tetraethylene glycol diacrylate, tetraethylene glycol diacrylate, tetraethylene glycol dimethacrylate, dipentaerythritol pentaacrylate, pentaethythritol tetraacrylate, pentaerythritol triacrylate, trimethylolpropane triacrylate, trimethylolpropane trimethacrylate, tris(2-hydroxyethyl)isocyanurate triacrylate, tris(2-hydroxy)isocyanurate trimethacrylate, dinvyl esters of polycarboxylic acids, diallyl esters of polycarboxylic acids, triallyl terephthalate, diallyl maleate, diallyl fumarate, hexamethylenebismaleinimide, trivinyl trimellitate, divinyl adipate, diallyl succinate, a divinyl ether of ethylene glycol, cyclopentadiene diacrylate, triallyamine, tetraallylammonium halides, divinylbezene, divinyl ethers, N,N′-methylene-bisacrylamide, N,N′-methylenebismethacrylamide, ethylene glycol dimethacrylate, or trimethylolpropane triacrylate, or mixtures composed of two or more of these. Examples of particularly suitable crosslinking agents are N,N′-methylenebisacrylamide, N,N′-methylenebismethacrylamide, polyethylene glycol diacrylate, polyethylene glycol dimethacrylate, or triallylamine, or mixtures composed of two or more of the compounds mentioned.

Polymer particles which may be used according to the invention may, by way of example, also have been post-crosslinked. Examples of these compounds which may be called “post-crosslinking agents” are organic carbonates, polyquaternary amines, polyvalent metal compounds, and compounds which have at least two functional groups which can react with carboxy groups of an untreated polymer particle. These are in particular polyols and amino alcohols, e.g. ethylene glycol, diethylene glycol, triethylene glycol, tetraethylene glycol, polyethylene glycol, glycerol, polyglycerol, propylene glycol, ethanolamine, diethanolamine, triethanolamine, propanolamine, polyoxypropylene, oxyethylene-oxypropylene block polymers, sorbitan fatty acid ester, polyoxyethylene sorbitan fatty acid ester, trimethylolpropane pentraerythritol, polyvinyl alcohol and the corresponding sorbitol compound, polyglycidyl ether compounds, such as ethylene glycol diglycidyl ether, polyethylene glycol diglycidyl ether, glycerol diglycidyl ether, glycerol polyglycidyl ether, pentraerythritol polyglycidyl ether, propylene glycol diglycidyl ether, and polypropylene glycol diglycidyl ether, polyacridine compounds, such as 2,2-bishydroxymethylbuntanol tris[3-(1-acridinyl)propionate], 1,6-hexamethylenediethyleneurea, and diphenylmethanebis-4,4′-N,N′-diethyleneurea, haloepoxy compounds, such as ethylenediamine, diethylenetriamine, triethylentetramine, tetra-ethylenepentamine, pentaethylenehexamine, and polyethyleneimines, polyisocyanates, such as toluylene 2,4-diisocyanate and hexamethylene diisocyanate, zinc hydroxides, calcium halides, aluminum halides, iron halides, titanium halides, and zirconium halides, alkylene carbonates, such as 1,3-dioxolan-2-on and 4-methyl-1,3-dioxolan-2-on, polyvalent metal compounds, such as salts., polyquaternary amines, such as condensates of dimethylamines and epicholorohydrin, homo- and copolymers of diallyldimethylammonium chloride, and homo- and copolymers of diethylallyamino(meth)acrylate methyl chloride ammonium salts. By way of example, particularly suitable compounds among these are diethylene glycol, triethylene glycol, polyethylene glycol, glycerol, polyglycerol, propylene glycol, diethanolamine, triethanolamine, polyoxypropylene, oxyethylene-oxypropylene block copolymer, sorbitan fatty acid ester, polyoxyethylene sorbitan fatty acid ester, trimethylolpropane, penterythritol, polyvinyl alcohol, sorbitol, alkylene carbonates, such as 1,3-dioxolan-2-one, 1,3-dioxolan-2-one, 4-methyl-1,3-dioxolan-2-one, 4,5-dimethyl-1,3-dioxolan-2-one, 4,4-dimethyl-1,3-dioxolan-2-one, 4-ethyl-1,3-dioxolan-2-one, 4-hydroxymethyl-1,3-dioxolan-2-one, 1,3-dioxan-2-one, 4-methyl-1,3-dioxan-2-one, 4,6-dimethyl-1,3-dioxan-2-one, 1,3-dioxepan-2-one, poly-1,3-dioxolan-2-one, or ethylene glycol diglycidyl ether, or mixtures composed of two or more of these.

By way of example, the amount used of the post-crosslinking agents during the preparation of the polymer particles which may be used according to the invention is from about 0.01 to about 30% by weight, or from about 0.1 to about 20% by weight, or from about 0.5 to about 10% by weight, based on the untreated polymer particle.

In another method for preparing the polymer particles which may be used according to the invention, particles are formed spontaneously during the precipitation of polymers from a solution. By way of example, therefore, suitable acrylic copolymers having quaternary ammonium groups are commercially obtainable as Eudragit® RS or Eudragit® RL (producer: Rohm GmbH, Darmstadt, Germany) are suitable for the preparation of appropriate polymer particles.

To this end, the appropriate acrylic copolymers are dissolved in the presence of the hydrophilic substance in an organic, water-miscible solvent, and then introduced into an amount of water sufficient for the precipitation, by way of example at least twice the amount of water. Particularly suitable organic water-miscible solvents are acetone, isopropanol, or ethanol. This process gives polymer particles whose diameter is from about 50 to about 500 nm. An appropriate process is described by way of example by R. Bodmeyer et al. in J. Microencapsulation, 1991, Vol. 8, No. 2, 161-170, the disclosure of that reference being expressly incorporated herein by way of reference, the disclosure of the cited text being regarded as part of the disclosure of the present text.

Polyurethanes are likewise suitable for use as polymer particles for the purposes of the inventive composition.

By way of example, the particulate polyurethanes which may be used according to the invention are obtainable by reacting
a) polyisocyanates with
b1) polyols whose molecular weight is 500 or above, or
b2) polyols whose molecular weight is below 500, or mixtures of b1) and b2), and
c) where appropriate, compounds having at least one group reactive toward isocyanates and having at least one group ionizable via addition of base or of acid.

The polyisocyanates usually used in polyurethane chemistry may be used as component a) to prepare the inventive polyurethanes.

Mention should in particular be made of the diisocyanates X(NCO)₂, where X is an aliphatic hydrocarbon radical having from 4 to 12 carbon atoms, a cycloaliphatic or aromatic hydrocarbon radical having from 6 to 15 carbon atoms, or an araliphatic hydrocarbon radical having from 7 to 15 carbon atoms. Examples of these diisocyanates are tetramethylene diisocyanate, hexamethylene diisocyanate, dodecamethylene diisocyanate, 1,4-diisocyanatocyclohexane, 1-isocyanato-3,3,5-trimethyl-5-isocyanatomethylcyclohexane (IPDI), 2,2-bis(4-isocyanatocyclohexyl)propane, trimethylhexane diisocyanate, 1,4-diisocyanatobenzene, 2,4-diisocyanatotoluene, 2,6-diisocyanatotoluene, 4,4-diisocyanatodiphenylmethane, tetramethylxylylene diisocyanate (TMXDI), 2,4′-diisocyanatodiphenylmethane, p-xylylene diisocyanate, the isomers of bis(4-isocyanatocyclohexyl)methane, such as the trans-trans isomer, the cis-cis isomer, and the cis-trans isomer, and also mixtures composed of these compounds.

Particularly significant mixtures of these isocyanates are the mixtures of the respective structural isomers of diisocyanatotoluene and diisocyanatodiphenylmethane, and a particularly suitable mixture is composed of about 80 mol % of 2,4-diisocyanatotoluene and about 20 mol % of 2,6-diisocyanatotoluene. Where appropriate, the aromatic diisocyanates may have been blended with aliphatic diisocyanates.

For preparing polyurethanes with a suitable degree of branching or of crosslinking, use may be made, for example, of tri- and/or tetrafunctional isocyanates. By way of example, these isocyanates may be obtained by reacting bifunctional isocyanates with one another in such a way that some of their isocyanate groups are derivatized to give allophanate groups, biuret groups, or isocyanurate groups.

Examples of commercially available compounds are the isocyanurate or the biuret of hexamethylene diisocyanate.

Other examples of suitable higher-functionality polyisocyanates are polyisocyanates having urethane groups and obtainable by reacting an excess of, by way of example, 2,4- and/or 2,6-diisocyanatotoluene, IPDI, or tetramethylene diisocyanate with low-molecular-weight polyhydroxy compounds, such as trimethylolpropane.

The component b1) used comprises, by way of example, relatively high-molecular-weight polyols whose molar mass is above 500 g/mol, for example from about 500 to 5000 g/mol, or from about 1000 to about 3000 g/mol.

Examples of suitable polyols of component b1) are the polyester polyols disclosed in Ullmanns Enzyklopädie der technischen Chemie [Ullmann's Encyclopedia of Industrial Chemistry], 4th Edition, Vol. 19, pp. 62-65. By way of example, use may be made of polyester polyols which are obtainable by reacting dihydric alcohols with polybasic, preferably dibasic, polycarboxylic acids. The polycarboxylic acids (component b1.1)) may be aliphatic, cycloalphatic, araliphatic, aromatic or heterocyclic, and, where appropriate, by way of example, have substitution by halogen atoms and/or have unsaturation. Examples which may be mentioned of these are suberic acid, azelaic acid, phthalic acid, isophthalic acid, terephthalic acid, phthalic anhydride, tetrahydrophthalic anhydride, hexahydrophthalatic anhydride, tetrachlorophthalic anhydride, endomethylenetetrahydrophthalic anhydride, glutaric anhydride, maleic acid, maleic anhydride, fumaric acid, and/or dimeric fatty acids. The synthesis of component b1) may either use the polycarboxylic acids mentioned individually as sole acid component or use them in a mixture with one another. Preference is given to the carboxylic acids of the general formula HOOC—(CH₂)_{y}—COOH, where y is a number from 1 to 20, preferably a number from 2 to 20, e.g. succinic acid, adipic acid, dodecanedicarboxylic acid and sebacic acid. Instead of the free polycarboxylic acids, use may, when possible, also be made of the corresponding polycarboxylic anhydrides or of the corresponding polycarboxylic esters of lower alcohols—or mixtures of these—as component b1.1) for preparing appropriate polyester polyols.

Examples of polyhydric alcohols which may be used as component b1.2) for the reaction with the polycarboxylic acid component for the synthesis of component b1) are ethylene glycol, 1,2-propanediol, 1,3-propanediol, 1,4-butanediol, 1,4-butenediol, 1,4-butynediol, 1,5-pentanediol, 1,6-hexanediol, neopentyl glycol, bis(hydroxylmethyl)cyclohexanes, such as 1,4-bis(hydroxymethyl)cyclohexane, 2-methylpropane-1,3-diol, methylpentanediols, and also diethylene glycol, triethylene glycol, tetraethylene glycol, polyethylene glycol, dipropylene glycol, polypropylene glycols, dibutylene glycol, and polybutylene glycol. Preference is given to neopentyl glycol and alcohols of the general formula HO—(CH₂)ₓ—OH, where x is a number from 1 to 20, preferably a number from 2 to 20. Examples of these are ethylene glycol, 1,4-butanediol, 1,6-hexanediol, 1,8-octanediol, and 1,12-dodecanediol.

Other components which may be used as component b1) are polycarbonatediols, e.g. those obtainable by reacting phosgene with an excess of the low-molecular-weight alcohols b1.2) mentioned as synthesis components for the polyesterpolyols.

Other compounds suitable as component b1) are polyesterdiols based on lactones, these being homo- or copolymers of lactones, preferably products obtained from addition reactions of lactones onto suitable difunctional starter molecules and having terminal hydroxy groups. Use is preferably made of lactones which derive from compounds of the general formula HO—(CH₂)ₙ—COOH, where z is a number from 1 to 20, preferably from 2 to 20. Examples are ε-caprolactone, β-propiolactone, γ-butyrolactone, or methyl-1-caprolactone, or else mixtures of two or more of these. Examples of suitable starter components are the low-molecular-weight dihydric alcohols mentioned above as component b1.2) for the polyester polyols. The corresponding polymers of ε-caprolactone are particularly preferred. It is also possible to use low-molecular-weight polyester polyols or polyetherdiols as starters for preparing the lactone polymers. Instead of the lactone polymers, use may also be made of the corresponding, chemically equivalent polycondensates of the hydroxycarboxylic acids corresponding to the lactones.

Polyetherdiols may also be used as component b1). They are in particular obtainable via homopolymerization ethylene oxide, propylene oxide, butylene oxide, tetrahydrofuran, styrene oxide, or epichlorohydrin, e.g. in the presence of BF₃, or via addition reactions of these compounds, where appropriate in a mixture or in succession, onto starter components having reactive hydrogen atoms, e.g. water or alcohols, for example ethylene glycol, 1,2-propanediol, 1,3-propanediol, 2,2-bis(4-hydroxydiphenyl)propane.

If the preparation of the polyurethanes uses suitable polyethers having polyethylene units with a molecular weight of at least about 150, preferably at least about 200, it is possible to prepare polyurethane particles which are at least substantially spontaneously dispersible in water and which do not require any use of other hydrophilic structural units.

For preparing the polyesterpolyols, and also for preparing the polyether polyols, use may be made of subordinate amounts of alcohols whose functionality is above 2, as component b1.3). Particular examples of these compounds are trimethylolpropane, pentaerythritol, glycerol, sugars, such as glucose, or obligomerized polyols, e.g. di- or trimeric ethers of trimethylolpropane, glycerol, or pentaerythritol. Where appropriate, the hydroxy groups of the polyols may have been etherified via reaction with alkylene oxides. The above compounds are likewise suitable as starter component for the synthesis of the polyether polyols.

Other compounds likewise suitable as component b1) are polyhydroxyolefins, such as those having two terminal hydroxy groups, e.g. α,ω-dihydroxypolybutadiene, α,ω-dihydroxypolymethacrylate, or α,ω-dihydroxy-polyacrylate.

The listed polyols which can be used as component b1) may also be used as mixtures in any desired ratios.

Alongside the polyols b1), low-molecular-weight di- or polyols, preferably diols, with a molar mass below 500 g/mol, preferably from 62 to 499 g/mol, and particularly preferably from 62 to 200 g/mol, may be used as polyols b2).

As component b2), use is particularly made of the short-chain alkanediols termed component b1.2), preference being given to neopentyl glycol and to the unbranched diols having from 2 to 12 carbon atoms, such as ethylene glycol, 1,3-propanediol, 1,4-butanediol, 1,5-pentanediol, or 1,6-hexanediol. Where appropriate, in order to generate crosslinking sites, component b2) may also comprise subordinate amounts of alcohols of higher functionality, for example those described as component b1.3).

For the purposes of the invention, the components b1) and b2) described for the synthesis of the inventive polyurethanes may also be used as mixtures of b1) and b2).

To achieve water-dispersibility of the polyurethanes, hydrophilicizing, nonionic or anionic structural units, or structural units capable of conversion into anionic groups, are usually incorporated into the polyurethanes.

For the purposes of the present invention, “structural units capable of conversion into anionic groups” means structural units which can be converted into an ionic form by a simple chemical reaction, such as addition of base. Examples of these are acid groups.

For the purposes of the invention, the expression “polyurethane substantially spontaneously dispersible in water” encompasses polyurethanes which are dispersible in particle form in water through addition of only very small amounts of dispersing agents, or indeed without any such addition. If polyurethane particles of this type are used within the scope of the invention, the order of size of the addition of dispersing agents, e.g. surfactants, that they require is at most about 5% by weight, preferably below 3% by weight, and particularly preferably below 1% by weight, based on the weight of solids in the dispersion, and in particular based on the weight of the polymer particles in the dispersion.

Alongside components a) and b1), and/or b2), compounds having at least one group reactive toward isocyanates and having at least one group capable of ionization through addition of acid or, or one group previously ionized through a reaction of this type may be incorporated as component c) during the preparation of the polyurethanes particles which may be used according to the invention. Unless otherwise stated, the expression “anionic groups” in the text hereinafter is used synonymously both for the groups ionized through addition of base and for the free acids.

The proportion of components having anionic groups, based on the entire amount of components a), b1), b2) and c), insofar as they are utilized in preparing the polyurethane particles, is generally adjusted so that the molar amount of the anionic groups, based on the weight of all of the components used, is from 0 to 1000 mmol/kg, for example from 0 to 600 mmol/kg, or from 0 to 500 mmol/kg.

The compounds incorporated as component c) into the polyurethane are particularly compounds bearing anionic groups, e.g. compounds bearing sulfonate groups, carboxylate groups, and phosphonate groups. By way of example, the anionic groups are incorporated in the form of the free acid, or else in the form of their alkali metal salts or ammonia salts, particularly suitable counterions being cationic groups such as ammonia groups, in particular protonated tertiary amino groups or quaternary ammonia groups.

Potential anionic hydrophilic groups are particularly those which can be converted into the above-mentioned anionic hydrophilic groups through simple neutralization reactions or hydrolysis reactions, e.g. carboxylic acid groups or anhydride groups.

The monomers used having anionic groups usually comprise aliphatic, cycloaliphatic, araliphatic, or aromatic carboxylic acids and sulfonic acids, which bear at least one alcoholic hydroxy group. Preference is given to the hydroxyalkanecarboxylic acids, especially those having from 3 to 10 carbon atoms, as also described in U.S. Pat. No. 3,412,054. Dimethylolpropionic acid (DMPA) is particularly preferred.

Appropriate dihydroxysulfonic acids and dihydroxyphosphonic acids are also suitable as component c).

For neutralization, the acid groups present, where appropriate, in the polyurethane particle which may be used according to the invention are neutralized by a basic neutralizing agent before, or preferably after, incorporation into the polyurethane chain. Suitable basic neutralizing agents are generally, by way of example, the alkali metals, such as Li, Na, or K, or else the alkaline earth metals, such as Ca, Mg, Ba, or Sr, although they are not preferred for the purposes of the present invention. Compounds which have better suitability and are preferred for the purposes of the present invention are all of those salts of the abovementioned metals which are capable of reacting to neutralize the acid groups, in particular the carbonates, the hydrogen carbonates, or particularly preferably the hydroxides, such as LiOH, NaOH, KOH, or Ca(OH) ₂.

Other compounds suitable for neutralization and particularly preferred for the purposes of the present invention are organic nitrogen-containing bases, such as ammonia and amines, e.g. trimethylamine, triethylamine, tributylamine, dimethylaniline, dimethylethanolamine, methyldiethanolamine, or triethanolamine, or else mixtures of these. The neutralization by the nitrogen-containing organic bases may take place in an organic phase or in an aqueous phase.

If the polyurethane particle which may be used according to the invention contains ionizable groups which are capable of conversion into anionic groups through addition of base, the amount of neutralizing agent added may be such as to neutralize a sufficient proportion of the ionizable groups, generally from about 0.1 to 100%. The extent to which neutralization occurs is generally at least 10%, preferably at least 25%, and particularly preferably at least 50%. However, the extent of neutralization of the ionizable groups present in the inventive polyurethane may also be at least 75%, or else, by way of example, substantially total, i.e. about 100%.

The polyurethane particles may be prepared through simultaneous reaction of all of the starting compounds. However, in many instances it is advantageous to prepare the polyurethane particles in stages. For example, a prepolymer containing isocyanate groups may be prepared from components A) and B), this then being further reacted, where appropriate, with component c).

The reaction of components a) to c) may also be carried out in the presence of catalysts. Tertiary amines are particularly suitable, e.g. triethylamine, 1,4-diazabicyclo[2.2.2]octane (=DABCO), dimethyl-benzylamine, bisdimethylaminoethyl ether, and bismethylaminomethylphenol. Particularly suitable compounds are 1-methylimidazole, 2-methyl-1-vinylimidazole, 1-allylimidazole, 1-phenylimidazole, 1,2,4,5-tetramethylimidazole, 1-(3-aminopropyl)-imidazole, pyrimidazole, 4-dimethylaminopyridine, 4-pyrrolidinopyridine, 4-morpholinopyridine, 4-methylpyridine.

It is also possible to use organotin compounds as catalysts. These are compounds which contain tin and also an organic radical, in particular compounds which contain one or more Sn—C bonds. Examples of organotin compounds in the wider sense are salts, such as tin octoate and tin stearate. Among the tin compounds in the narrower sense are in particular compounds of tetravalent tin of the general formula RSₙX₃₋₁₁, where n is a number from 0 to 2, R is an alkyl group or a aryl group or both, and finally X is an oxygen grouping, sulfur grouping, or nitrogen grouping, or a mixture of two or more of these. R advantageously contains at least 4 carbon atoms, in particular at least 8. The upper limit is generally 12 carbon atoms.

X is preferably an oxygen grouping, i.e. an organotin oxide, hydroxide, carboxylate, or an ester of an inorganic acid. However, X may also be a sulfur grouping, i.e. an organotin sulfide, thiolate, or a thioacid ester. Among the Sn—S groupings, thioglycolic esters are particularly suitable, e.g. compounds having the following radicals: —S—CH₂—CH₂—CO—O—(CH₂)—CH₃, or —S—CH₂—CH₂—CO—Q—CH₂—CH(C₂H₅)—CH₂—CH₂—CH₂—CH₃.

Compounds of this type comply with another selection rule: in one preferred embodiment of the invention, the molecular weight of the organotin compound is intended to be above 250, in particular above 600.

Another preferred class of compound is represented by the dialkyltin(IV) carboxylates (X═O—CO—R′). The carboxylic acids have 2, preferably at least 10, in particular from 14 to 32, carbon atoms. It is also possible to use dicarboxylic acids. Examples of suitable acids are adipic acid, maleic acid, fumaric acid, terephthalic acid, phenylacetic acid; benzoic acid, acetic acid, propionic acid, and also in particular caprylic acid, capric acid, lauric acid, myristic acid, palmitic acid, and stearic acid. By way of example, particularly suitable compounds are dibutyltin diacetate and dibutyltin dilaurate, and also dioctyltin diacetate and dioctyltin dilaurate.

For the purposes of the present invention, tin oxides and tin sulfides are also suitable, as are tin thiolates. Specific compounds are: bis(tributyltin) oxide, dibutyltin didodecylthiolate, dioctyltin dioctylthiolate, dibutyltin bis(2-ethylhexyl thioglycolate), octyltin tris(2-ethylhexyl thioglycolate), dioctyltin bis(thio(ethylene glycol) 2-ethylhexoate), dibutyltin bis(thio(ethylene glycol) laurate), dibutyltin sulfide, dioctyltin sulfide, bis(tributyltin) sulfide, dibutyltin bis(2-ethylhexyl thioglycolate), dioctyltin bis(thio(ethylene glycol) 2-ethylhexoate), trioctyltin thio(ethylene glycol) 2-ethylhexoate, and dioctyltin bis(2-ethylhexyl thiolatoacetate), bis(S,S-methoxycarbonylethyl)tin bis(2-ethylhexyl thiolatoacetate), bis(S,S-acetylethyl)tin bis(2-ethylhexyl thiolatoacetate), tin(II) octylthiolate, and tin(II) thio(ethylene glycol) 2-ethylhexoate.

Mention may also be made of: dibutyltin diethanolate, dihexyltin dihexanolate, dibutyltin diacetylacetonate, dibutyltin diethylacetylacetate, bsi(butyldichlorotin) oxide, bis(dibutylchlorotin) sulfide, tin(II) phenolate, tin(II) acetylacetonate, and also other β-dicarbonyl compounds, such as acetylacetone, dibenzolymethane, benzoylacetone, ethyl acetoactate, n-propyl acetoactate, ethyl diphenylacetoacetate, and dehydroacetoacetic acid.

The catalyst is preferably added to the polyol. Its amount depends on its activity and on the reaction conditions. It is preferably in the range from 0.001 to 0.5% by weight, based on the polyol.

However, it is preferable to operate without catalyst. The solvent, too, is advantageously omitted. For the purposes of the present text, “solvents” are inert organic liquid substances whose boiling point is below 200° C. at atmospheric press (1 bar).

The reaction is preferably undertaken in such a way that the ratio of OH groups in the polyol component to NCO groups in the polyisocyanate is from about 1.0 to about 2.0, in particular from about 1.05 to 1.8, for example from about 1.1 to 1.7, or from about 1.3 to 1.6.

One way of introducing ion-forming structural elements is the reaction of OH-terminated polyurethane oligomers with dicarboxylic anhydrides. These may contain a total of from 2 to 44 carbon atoms, preferably from 2 to 12 carbon atoms, between the bisacyl groups, e.g. an alkylene grouping, alkenylene grouping, or arylene grouping. By way of example, suitable compounds are succinic anhydride, glutaric anhydride, 1,2,3,6-tetrahydrophthalate anhydride and its isomers, phthalic anhydride, trimellitic anhydride, 7-oxabicyclo[2.2.1]hept-5-en-2,3-dicarboxylic anhydride, 5-norbornen-2,3-dicarboxylic anhydride and their isomers, diglycolic anhydride, maleic anhydride, dimethylmaleic anhydride, citraconic anhydride, itaconic anhydride, alkenylsuccinic anhydrides, preferably those whose alkenyl groups have more than 2 carbon atoms, in particular more than 5, particularly preferably more than 7 carbon atoms. Specific mention may be made of: n-octenylsuccinic anhydride, n-dodecenylsuccinic anhydride, tetrapropenylsuccinic anhydride, n-hexadecenylsuccinic anhydride, and n-octadecenylsuccinic anhydride. The alkenyl radical may have a linear or branched structure. Mixtures of alkenyl groups with a different number of carbon atoms may moreover occur. Mixtures of two or more anhydrides are also possible, but preference is given to cyclic anhydrides.

However, it is also possible to use a molar excess of isocyanates, thus giving NCO-terminated oligomers.

Although NCO groups are generally undesirable in the final product, they may be used in order, for example, to introduce hydrophobic or ionic structural elements.

By way of example, hydrophobic structural elements may be present through reaction of NCO-terminated oligomers with monools or with monofunctional amines having from 2 to 22 carbon atoms, in particular more than 6, more than 10, or more than 16 carbon atoms. Specific mention may be made of: polyethylene-butylene having 1 OH group, e.g. with an OH equivalent weight of 3600 (Kraton L 1203), and also 1-hexanol, 1-heptanol, 1-octanol, 1-nonanol, 1-decanol, 1-undecanol, 10-undecen-1-ol, 1-dodecanol, 1-tridecanol, 1-tetradecanol, 1-pentadecanol, 1-hexadecanol, 1-heptadecanol, 1-octadecanol 9-cis-octadecene-1-ol, 9-trans-octadecen-1-ol, 9-cis-octadecen-1,12-diol, all-cis-9,12-octadecadien-1-ol, all-cis-9,12,15-octadecatrien-1-ol, 1-nonadecanol, 1-eicosanol, 9-cis-eicosen-1-ol, 5,8,11,14-eicosatetraen-1-ol, 1-heneicosanol, 1-docosanol, 13-cis-docosen-1-ol, 13-trans-docosen-1-ol. The corresponding fatty amines are also possible hydrophobicizing structural elements.

Finally, another way of introducing ion-forming structures is the reaction of NCO-terminated oligomers with hydroxycarboxylic acids or aminocarboxylic acids having alkylene groupings, alkenylene groupings, or arylene groupings, as is the case with the dicarboxylic anhydrides. Examples which may be mentioned are: glycolic acid, lactic acid, caproic acid, and mandelic acid, and also aminocaproic acid, aminododecanoic acid, glycine, alanine, and phenylalanine.

The amounts to be used of components a), b) and c) are a function of the desired number-average molecular weight, the desired number of ionic groups, and the desired degree of crosslinking.

The polyurethane particles which may be used according to the invention may be prepared in the presence of organic solvents, or in the melt. Solvents used are generally liquid, aliphatic ketones, such as acetone, methyl ethyl ketone, or methyl isobutyl ketone, esters of aliphatic monocarboxylic acids, e.g. methyl acetate, ethyl acetate, propyl acetate, or isobutyl acetate, aromatic hydrocarbons, such as toluene or xylolene, or nitrogen-containing polar aprotic solvents, such as dimethylformamide (DMF), dimethylacetamide (DMAc), or N-methylpyrrolidone (NMP). The stated solvents may be used alone or in a mixture. It is generally preferable to use acetone or methyl ethyl ketone, or mixtures composed of acetone and methyl ethyl ketone.

By way of example, one method for preparing polyurethane particles which may be used according to the invention from polymers of this type prepared in solution introduces the polymer solution into water. The introduction should preferably take place with vigorous stirring. If the polymer was prepared in a water-miscible solvent, appropriate selection of the proportion of hydrophilic groups in the polymer can give precipitation particles whose particle size is within the limits stated above. If the preparation of the polymer used a solvent immiscible with water, a possible method is emulsification in water of the polymer dissolved in a solvent immiscible with water, whereupon the droplet size of the emulsion may be adjusted, via stirring conditions, emulsifier type and amount of emulsifier, so that it substantially corresponds to the particle size required for the polymer particles. The solvent is then removed, e.g. in vacuo.

This method can give porous particulate polymers which comply with the inventive specification. If, therefore, use is made of suitable polymer types for the abovementioned process, for example those listed within the scope of the present text, the polymer particles produced may be used according to the invention. However, for the purposes of the present invention it is also possible for the polymer particles resulting from the process described to be crosslinked after the preparation process, i.e. if the particle size of the polymer particles is within the limits defined according to the invention for the particle size, prior to the removal of the solvent. This requires use of appropriate polymers which have a functional group or have a mixture composed of two or more functional groups, which can be crosslinked by an ionic, covalent, or coordinative route, by means of suitable crosslinking agents.

For the purposes of one preferred embodiment of the present invention, by way of example, water-insoluble polymers, such as ethylcellulose, polyvinyl acetate, or cellulose acetate butryrate, or water-insoluble copolymers of polyvinylpyrrolidone and polyvinyl acetate, together with a hydrophilic compound, preferably a surfactant, are dissolved here in a solvent immiscible with water. It is preferable here to use a solvent immiscible with water which is more volatile than water. Water, to which an ionic surfactant has been added at a concentration below the critical micelle-forming concentration (CMC), is then introduced into this solution, with stirring. During the dropwise addition of water, an O/W emulsion is produced. Once dropwise addition of the water has been completed, by way of example, the polymer is then crosslinked within the organic phase, or the solvent is then drawn off in vacuo. This gives a dispersion whose particle size is controllable via the stirring conditions and via the amount of surfactant present in the water, and its type.

The median particle size of a particulate polymer which can be used for the purposes of an inventive preparation is preferably from about 10 nm to 50 μm. A median particle size is in particular from about 20 nm to about 40 μm, for example from about 50 nm to about 20 μm, or from about 100 nm to about 10 μm. Polymer particles which are particularly suitable are moreover those whose median particle size is from about 30 nm to about 5 μm, from about 50 nm to about 3 μm, or from about 100 nm to about 1 μm.

A polymer particle which may be used for the purposes of the present invention has water-solubility below 2 g/l at a temperature below 40° C. at a pH of from 5 to 8. However, the water-solubility is preferably lower, e.g. below 1 g/l, or below 0.5 g/l, in particular below 0.1 g/l. For the purposes of one particularly preferred embodiment of the present invention, a polymer particle which may be used according to the invention is insoluble in water under the abovementioned conditions.

A polymer particle which may be used for the purposes of the present invention may be spontaneously dispersible in water. For the purposes of the present invention, the expression “spontaneously disposable” means that a polymer particle which may be used according to the invention can be stably dispersed in water for a period of at least 1 h without further dispersing agents, e.g. without further surfactants in aqueous solution. However, for the purposes of the present invention it is also possible to use polymer particles which are dispersible in water only with the aid of a dispersing agent, e.g. of a surfactant.

An inventive composition comprises not only a polymer particle as described above within the scope of the present text, or a mixture composed of two or more such polymer particles, but also at least one hydrophilic substance with a molecular weight below about 1000.

For the purposes of the present text, the expression “hydrophilic substance” here encompassed all of the compounds which are soluble, or at least spontaneously dispersible for a certain period, in water under the abovementioned conditions. For the purposes of the present invention, it is sufficient that a “hydrophilic substance” forms a non-separating dispersion for at least 5 min, preferably at least 10 min, after dispersion in water has taken place. For the purposes of one preferred embodiment of the present invention, a “hydrophilic substance” which may be used for the purposes of the present invention is a surfactant, i.e. an amphiphilic compound.

For the purposes of the present invention, all surfactants are in principle suitable as hydrophilic substances.

By way of example, surface-active substances from the group of the anionic, nonionic, zwitterionic, or cationic surfactants may be used in inventive compositions.

By way of example, anionic surfactants which may be used are those of the sulfonates and sulfates type. Sulfonate-type surfactants which may be used here are preferably C₉₋₁₃-alkylbenzenesulfonates, olefin-sulfonates, i.e. mixtures composed of alkene- and hydroxyalkanesulfonates, and also of disulfonates, for example those obtained from C₁₂₋₁₈ monoolefins having a terminal or internal double bond via sulfonation, using gaseous sulfur trioxide, followed by alkaline or acidic hydrolysis of the sulfonation products. Other suitable compounds are alkanesulfonates obtained from C₁₂₋₁₈ alkanes, e.g. via sulfochlorination or sulfoxidation, followed by hydrolysis or neutralization. Other suitable compounds are the esters of 2-sulfo-substituted fatty acids (estersulfonates), e.g. the 2-sulfonated methyl esters of hydrogenated coconut fatty acids, hydrogenated palm kernel fatty acids, or hydrogenated tallow fatty acids.

Other suitable anion surfactants are sulfated glycerol esters of fatty acids. Glycerol esters of fatty acids are the mono-, di-, and triesters, and also mixtures of these, as obtained during the preparation process via esterification of a monoglycerol, using from 1 to 3 mol of fatty acid, or during the transesterification of triglycerides, using from 0.3 to 2 mol of glycerol. Preferred sulfated glycerol esters of fatty acids here are the sulfation products of saturated fatty acids having from 6 to 22 carbon atoms, e.g. of caproic acid, caprylic acid, capric acid, myristic acid, lauric acid, palmitic acid, stearic acid, or behenic acid.

Preferred alk(en)yl sulfates are the alkali metal salts of the sulfuric half-esters of the C₁₂-C₁₈ fatty alcohols, and in particular the sodium salts of the same esters, e.g. those derived from coconut fatty alcohol, tallow fatty alcohol, lauryl alcohol, myristyl alcohol, cetyl alcohol, or stearyl alcohol, or from the C₁₀-C₂₀ oxo alcohols, preference also being given to the half-esters of secondary alcohols of these chain lengths. Preference is also given to alk(en)yl sulfates of the chain length mentioned which contain a synthetic straight-chain alkyl radical prepared by petrochemical methods, where these compounds have degradation behavior analogous to that of the suitable compounds based on raw materials derived from the chemistry of fats. From a detergents standpoint, C₁₂-C₁₆ alkyl sulfates and C₁₂-C₁₅ alkyl sulfates are preferred, as are C₁₄-C₁₅ alkyl sulfates. 2,3-Alkyl sulfates, which may be prepared as in the US patent specification 3,234,258 or 5,075,041, for example, and are commercially available products from Shell Oil Company with the name DAN®, are also suitable anion surfactants.

Other suitable compounds are the sulfuric monoesters of the straight-chain or branched C₇₋₂₁ alcohols ethoxylated with from 1 to 6 mol of ethylene oxide, e.g. 2-methyl-branched C₉₋₁₁ alcohols with an average of 3.5 mol of ethylene oxide, or C₁₂₋₁₈ fatty alcohols with from 1 to 4 EO. They are used only in relatively small amounts in cleaning compositions, for example in amounts of from 1 to 5% by weight, because they have a strong foaming tendency.

Other suitable anion surfactants are the salts of alkylated sulfosuccinic acid, these also being termed sulfosuccinates or sulfosuccinic esters, and the monoesters and/or diesters of sulfosuccinic acid with alcohols, preferably with fatty alcohols, and particularly with ethoxylated fatty alcohols. Preferred sulfosuccinates contain C₈₋₁₈ fatty alcohol radicals or mixtures composed of these. Particularly preferred sulfosuccinates contain a fatty alcohol radical which derives from ethoxylated fatty alcohols which are themselves nonionic surfactants (see description below). Particular preference is in turn given here to sulfosuccinates whose fatty alcohol radicals derive from ethoxylated fatty alcohols with a narrow homolog distribution. It is likewise possible to use alk(en)ylsuccinic acid which preferably has from 8 to 18 carbon atoms in the alk(en)yl chain, or its salts.

Other anionic surfactants which may in particular be used are soaps. Suitable compounds are saturated fatty acid soaps, such as the salts of lauric acid, myristic acid, palmitic acid, stearic acid, hydrogenated erucic acid, and behenic acid, and also in particular soap mixtures derived from natural fatty acids, e.g. coconut fatty acids, palm kernel fatty acids, or tallow fatty acids.

The anionic surfactants, including the soaps, may be present in the form of their sodium salts, potassium salts, or ammonium salts, or else as soluble salts of organic bases, such as mono-, di- or triethanolamine. The anionic surfactants are preferably present in the form of their sodium salts or potassium salts, in particular in the form of the sodium salts. In another embodiment of the invention, surfactants are used in the form of their magnesium salts.

Examples of particularly suitable anionic surfactants are ammonium polyoxyethylene alkylphenyl ethersulfonate, sodium polyoxyethylene alkylphenyl ethersulfonate, potassium soaps, sodium soaps, sodium dioctyl sulfosuccinate, alkyl sulfates, alkyl ether sulfates, sodium alkyl sulfate, sodium alkyl ether sulfate, polyoxyethylene alkyl ether sulfates, sodium polyoxyethylene alkyl ether sulfate, triethanolamine alkyl sulfate, triethanolamine polyoxyethylene alkyl ether sulfate, the sodium salt of 2-ethylhexylalkyl sulfate, sodium acylmethyltaurates, sodium lauroylmethyltaurate, sodium dodecylbenzenesulfonate, disodium lauryl sulfosuccinate, ethoxylated disodium lauryl sulfosuccinate, polycarboxylic acids, oleylsarcosine, amidoether sulfates, lauroylsarcosinate, or sodium salts of esters of sulfo-substituted fatty acids, or mixtures composed of two or more of these.

Compositions preferred for the purposes of the present invention are those which comprise from 1 to 70% by weight, preferably from 2 to 60% by weight, and in particular from 3 to 50% by weight, of one or more anionic surfactants, based in each case on the entire composition.

For the purposes of one preferred embodiment of the present invention, an inventive composition comprises, as hydrophilic compound, at least one nonionic surfactant. Nonionic surfactants used are preferably alkoxylated, for example, ethoxylated, in particular primary alcohols preferably having from 8 to 18 carbon atoms and an average of from 1 to 12 mol of ethylene oxide (EO) per mole of alcohol, where the alcohol radical may be linear or methyl-branched, preferably in the 2-position, or may contain a mixture of linear and methyl-branched radicals, such as those usually present in oxo alcohol radicals. However, particular preference is given to alcohol ethoxylates having linear radicals derived from native alcohols having from 12 to 18 carbon atoms, e.g. derived from coconut alcohol, from palm alcohol, from tallow fatty alcohol, or from oleyl alcohol, and having an average of from 2 to 8 EO per mole of alcohol. Among the preferred ethoxylated alcohols are, by way of example, C₁₂₋₁₄ alcohols having from 2 to 4 EO, C₉₋₁₁ alcohols having from 2 to 7 EO, C₁₃₋₁₅ alcohols having from 2 to 8 EO, C₁₂-18 alcohols having from 2 to 7 EO, and mixtures composed of these, and also mixtures composed of C₁₂-14 alcohol having from 2 to 4 EO and C₁₂-18 alcohol having from 2 to 5 EO. The stated degrees of ethoxylation are statistical average values which, for a specific product, may be a whole number or a fractional number. Preferred alcohol ethoxylates have a narrow distribution of homologs (narrow range ethoxylates, NRE). In addition to these nonionic surfactants, use may also be made of fatty alcohols having more than 12 EO. Examples of these are tallow fatty alcohol having 14 EO, 25 EO, 30 EO, or 40 EO.

For the purposes of the present invention, other nonionic surfactants which are likewise suitable are EO/PO adducts of the abovementioned alcohols, in particular of the abovementioned primary alcohols preferably having from 8 to 18 carbon atoms and an average total of from 1 to 12 mol of ethylene oxide and of propylene oxide (EO/PO) per mole of alcohol, where the alcohol radical may be linear or preferably methyl-branched in the 2-position, or may contain a mixture of linear and methyl-branched radicals, such as those usually present in oxo alcohol radicals. However, particular preference is given to alcohol EO/PO adducts having linear radicals derived from native alcohols having from 12 to 18 carbon atoms, e.g. derived from coconut alcohol, from palm alcohol, from tallow fatty alcohol, or from oleyl alcohol, and having an average of from 2 to 8 EO/PO per mole of alcohol. Among the preferred ethoxylated alcohols are, by way of example, C₁₂-14 alcohols having from 2 to 4 EO/PO, Cg-ll alcohols having from 2 to 7 EO/PO, C₁₃-15 alcohols having from 2 to 8 EO/PO, C₁₂-18 alcohols having from 2 to 7 EO/PO, and mixtures composed of these, and also mixtures composed of C₁₂-14 alcohol having from 2 to 4 EO/PO and C₁₂-18 alcohol having from 2 to 5 EO/PO. The stated degrees of alkoxylation are statistical average values which, for a specific product, may be a whole number or a fractional number. Preferred alcohol EO/PO alkoxylates have a narrow distribution of homologs. In addition to these nonionic surfactants, use may also be made of fatty alcohols having more than 12 EO/PO. The EO units and PO units may be present in the polymer with random distribution or as blocks. The ratio of EO units to PO units is from about 10:1 to about 1:10.

For the purposes of the present invention, the abovementioned adducts of EO or of EO/PO may have, to a substantial extent, any desired end groups, such as OH end groups. However, the invention also envisages that the compounds known as end-group-capped polyalkylene glycols are used as nonionic surfactants. In the case of these polyalkylene glycols, the OH end group has been capped by a linear or branched alkyl group. Examples of these end-group-capped polyalkylene glycols are polyethylene glycol di-C₁₋₁₀-alkyl ethers or polypropylene glycol di-C₁₋₁₀-alkyl ethers.

Another class of nonionic surfactants whose use is preferred and which are used either as sole nonionic surfactant or in combination with other nonionic surfactants is that of alkoxylated, preferably ethoxylated or ethoxylated and propoxylated alkyl esters of fatty acids, preferably having from 1 to 4 carbon atoms in the alkyl chain, in particular methyl esters of fatty acids, such as those described by way of example in the Japanese patent application JP 58/217598, or those preferably prepared by the process described in the international patent application WO-A-90/13533.

Another class of nonionic surfactants which may be used with advantage is that of the alkyl polyglycosides (APGs). Alkyl polyglycosides which may be used comply with the general formula RO(G)_{z}, where R is a linear or branched, in particular 2-position methyl-branched, saturated or unsaturated, aliphatic radical having from 8 to 22, preferably from 12 to 18, carbon atoms, and G is the symbol representing a glycose unit having 5 or 6 carbon atoms, preferably glucose. The degree of glycosidation z is from 1.0 to 4.0, preferably from 1.0 to 2.0, and in particular from 1.1 to 1.4.

Use is preferably made of linear alkyl polyglucosides, i.e. alkyl polyglycosides where the polyglycosyl radical is a glucose radical and the alkyl radical is an n-alkyl radical.

Nonionic surfactants of amine oxide type may also be suitable, for example N-cocoalkyl-N,N-dimethylamine oxide and N-tallowalkyl-N,N-dihydroxyethylamine oxide, and the alkanolamides of fatty acids. The amount of these nonionic surfactants is preferably not more than that of the ethoxylated fatty alcohols, in particular not more than half thereof.

Other suitable surfactants are polyhydroxy-substituted fatty amines of the formula (I), 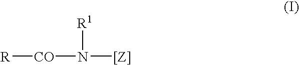
where RCO is an aliphatic acyl radical having from 6 to 22 carbon atoms, R¹ is hydrogen, or an alkyl or hydroxyalkyl radical having from 1 to 4 carbon atoms, and [Z] is a linear or branched polyhydroxyalkyl radical having from 3 to 10 carbon atoms and from 3 to 10 hydroxy groups. The polyhydroxy-substituted fatty amides are known substances which may usually be obtained via reductive amination of a reducing sugar with ammonia, with an alkylamine, or with an alkanolamine, followed by acylation with a fatty acid, with an alkyl ester of a fatty acid, or with a chloride of a fatty acid.

Among the group of the polyhydroxy-substituted fatty amides there are also compounds of the formula (II), 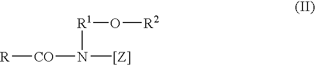
where R is a linear or branched alkyl or alkenyl radical having from 7 to 12 carbon atoms, R¹ is a linear, branched or cyclic alkyl radical or an aryl radical having from 2 to 8 carbon atoms, and R² is a linear, branched or cyclic alkyl radical or an aryl radical or an oxyalkyl radical having from 1 to 8 carbon atoms, where C₁₋₄-alkyl or phenyl radicals are preferred, and [Z] is a linear polyhydroxyalkyl radical whose alkyl chain has been substituted with at least two hydroxy groups, or is alkoxylated, preferably ethoxylated or propoxylated, derivatives of this radical.

[Z] is preferably obtained via reductive amination of a reduced sugar, such as glucose, fructose, maltose, lactose, galactose, mannose or xylose. The N-alkoxy- or N-aryloxy-substituted compounds may then, by way of example, be converted into the desired polyhydroxy-substituted fatty amines in accordance with the teaching of the international application WO-A-95/07331 via reaction with methyl esters of fatty acids in the presence of an alkoxide as catalyst.

For the purposes of the present invention, preference is given to compositions which comprise from 1 to 70% by weight, preferably from 2 to 60% by weight, and in particular from 3 to 50% by weight, of one or more nonionic surfactants, based in each case on the entire composition.

For the purposes of the present invention, the inventive compositions may also comprise cationic or ampholytic surfactants as hydrophilic compounds. Examples of cationic surfactants are salts of primary, secondary, or tertiary fatty amines having from about 8 to about 24 carbon atoms with acetic acid, sulfuric acid, hydrochloric acid, or phosphoric acids, quaternary alkyl- and alkylbenzene ammonium salts, in particular those whose alkyl groups have from about 6 to about 24 carbon atoms, in particular the halides, sulfates, phosphates, or acetates, or mixtures composed of two or more of these, alkylpyridinium salts, alkylimidazolinium salts, or alkyloxazolidinium salts, in particular those whose alkyl chain has up to about 18 carbon atoms, e.g. the halides, sulfates, phosphates, or acetates, or mixtures composed of two or more of these. Other compounds suitable as cationic surfactants are those known as ester quats.

Examples of ampholytic surfactants are long-chain-substituted amino acids, such as N-alkyldi(aminoethyl)glycine or N-alkyl-2-amino-propionic salts, betaines, such as N-(3-acylamidopropyl)-N,N-dimethylammonium salts having a C₈₋₁₈-acyl radical, or alkylimidazolium betaines.

For the purposes of one preferred embodiment of the present invention, the hydrophilic compounds used as a constituent of the inventive compositions comprise those which in aqueous solutions together with a particulate porous polymer as described above within the scope of this text exhibit a distribution equilibrium. For the purposes of the present invention, a “distribution equilibrium” is a condition in which the hydrophilic compounds are to some extent present in aqueous solution or dispersion and to some extent are present within the interior of the polymer particle or adsorbed on the surface of the polymer particle.

For the purposes of one preferred embodiment of the present invention, the distribution equilibrium between hydrophilic compound or mixture composed of two or more hydrophilic compounds in aqueous solution or dispersion as defined above and hydrophilic compound or mixture composed of two or more hydrophilic compounds which have been adsorbed on or within a polymer particle or on or within a mixture composed of two or more polymer particles is from about 1:100 to about 100:1, based on the weight of the hydrophilic compound. For the purposes of the present invention, it is sufficient here for one of the hydrophilic compounds present in the inventive composition to exhibit a distribution equilibrium within the specified limits.

For the purposes of the invention, it is preferable to use combinations composed of hydrophilic compounds and polymer particles which exhibit a distribution equilibrium, in the above sense, of from about 1:1 to about 1:80, or from about 1:2 to about 1:60.

For the purposes of another preferred embodiment of the present invention, the hydrophilic compounds used comprise nonionic surfactants whose HLB value is from about 4 to about 25, in particular from about 5 to about 22, or from 6 to about 18, for example from about 7 to about 14.

Besides the constituents described hitherto, namely one or more porous, particulate polymers and one or more hydrophilic compounds, an inventive composition may also comprise other additives.

By way of example, suitable other additives are water-soluble compounds with a molecular weight above 1000. Among these are, by way of example, polyacrylic acid, polymethacrylic acid, polyalkylene oxides, such as polyethylene glycol or polypropylene glycol, polyvinylpyrrolidone, polyoxazolines, polyvinyl alcohols, isobutylene-maleic anhydride copolymers, polyacrylamide, cellulose derivatives, such as viscose, hydroxyethylcellulose, hydroxypropylcellulose, or carboxymethylcellulose, starch derivatives, such as soluble starch or carboxymethyl starch, agarose, or hyaluronic acid. Other compounds suitable as other additives are cellulose acetate, cellulose nitrate, cellulose acetate butyrate, gelatin, curdlan, alginates, pectinates, carageenans or chitosans.

Other compounds suitable as other additives are water-soluble or water-insoluble inorganic substances, such as phyllosilicates, sepiolites, kaolin, silica gel, or waterglass.

For the purposes of one preferred embodiment of the present invention, an inventive composition comprises at least one solvent. Suitable solvents are in principle water and all of the solvents which are miscible with water and have a boiling point below about 120° C., preferably below about 100° C. For the purposes of the present invention, particularly suitable compounds are water, ethanol, propanol, isopropanol, or acetone, or mixtures composed of two or more of these.

An inventive composition may moreover comprise compounds which regulate pH. Suitable compounds for regulating pH are in principle all of the buffer systems or bases or acids soluble in one of the abovementioned solvents. For the purposes of the present invention, examples of particularly suitable compounds are alkali metal hydroxides, such as NaOH or KOH, carbonates, silicates, phosphates, hydrogenphosphates, sulfates, citrates, borates, or salts of carboxylic acids.

For the purposes of the inventive compositions, other compounds suitable as other additives are plasticizers, where these are also suitable film-forming auxiliaries. By way of example, suitable plasticizers are phthalates (phthalic esters), such as dioctyl phthalate [DOP; bis(2-ethylhexyl) phthalate], diisononyl phthalate (DINP), diisodecyl phthalate (DIDP), phthalate esters with (predominantly) linear C6-C11 alcohols, e.g. dibutyl phthalate (DBP), diisobutyl phthalate (DIBP), dicyclohexyl phthalate (DCHP), dimethyl phthalate (DMP), or diethyl phthalate (DEP), benzyl butyl phthalate (BBP), butyl octyl phthalate, butyl deecyl phthalate, or dipentyl phthalate, bis(2-methoxyethyl) phthalate, or dihexyldicapryl phthalate (DCP), or mixtures composed of two or more of these.

Other suitable plasticizers are trimellitates (trimellitic esters) with (predominantly) linear C6-C11 alcohols, e.g. tris(2-ethylhexyl) trimellitate (TOTM).

Other suitable plasticizers are acyclic (aliphatic) dicarboxylic esters, such dioctyl adipate [DOA; bis(2-ethylhexyl) adipate] or diisodecyl adipate (DIDA). Dibutyl sebacate (DBS), dioctyl sebacate [DOS, bis(2-ethylhexyl) sebacate], or esters of azelaic acid are also suitable.

Other suitable plasticizers are polymer plasticizers, such as polyesters derived from adipic, sebacic, azelaic and phthalic acid with diols, such as 1,3-butanediol, 1,2-propanediol, 1,4-butanediol, 1,6-hexanediol. Use may also be made of butadiene-acrylonitrile copolymers as polymeric plasticizers.

Other plasticizers besides these are phosphates (phosphoric esters), such as tricresyl phosphate (TCF), triphenyl phosphate (TPF), diphenyl cresyl phosphate (DPCF), diphenyl octyl phosphate (DPOF, 2-ethylhexyl diphenyl phosphate], or tris(2-ethylhexyl) phosphate (TOF), tris(2-butoxyethyl) phosphate.

Other suitable plasticizers are esters of fatty acids, such as butyl oleate or butyl stearate, methyl or butyl esters of acetylated castor oil fatty acid, or glycol esters of fatty acids, e.g. triethylene glycol bis(2-ethylbutyrate).

Other suitable plasticizers are hydroxycarboxylic esters, such as citric esters, e.g. tributyl O-acetylcitrate or triethyl O-acetylcitrate, or tartaric esters, or lactic esters.

Other suitable plasticizers are epoxy plasticizers, such as epoxidized derivatives of fatty acids, e.g. triglycerides or monoesters, such as epoxy stearate esters or epoxidized soy oils (EPSO), or linseed oils (EPLO).

Other additives which may be present in the inventive composition are UV stabilizers, antioxidants, fragrances, dyes, preservatives, complexing agents, and the like.

Among the stabilizers or antioxidants which may be used as additives for the purposes of the invention are hindered phenols of high molecular weight (Mₙ), polyfunctional phenols, and sulfur- and phosphorus-containing phenols. Examples of phenols which may be used as additives for the purposes of the invention are 1,3,5-trimethyl-2,4,6-tris(3,5-di-tert-butyl-4-hydroxy-benzyl)benzene; pentaerythritol tetrakis-3-(3,5-di-tert-butyl-4-hydroxyphenyl)propionate; n-octadecyl 3,5-di-tert-butyl-4-hydroxyphenyl)propionate; 4,4-methylenebis(2,6-di-tert-butylphenol); 4,4-thiobis(6-tert-butyl-o-cresol); 2,6-di-tert-butylphenol; 6-(4-hydroxyphenoxy)-2,4-bis(n-octylthio)-1,3,5-triazine; di-n-octadecyl 3,5-di-tert-butyl-4-hydroxybenzyl-phosphonate; 2-(n-octylthio)ethyl 3,5-di-tert-butyl-4-hydroxybenoate; and sorbitol hexa[3-(3,5-di-tert-butyl-4-hydroxyphenyl)propionate].

For the purposes of one preferred embodiment of the present invention, an inventive composition comprises at least about 10% by weight, for example at least about 20% by weight, or at least about 50% by weight, of water.

The form in which an inventive composition is present here may be that of a low-viscosity aqueous liquid, a medium- or high-viscosity aqueous liquid, a gel, or a paste. For the purposes of one preferred embodiment of the present invention, the form in which an inventive composition is present is that of a low-viscosity, aqueous liquid.

For the purposes of one preferred embodiment of the present invention, the content of porous, particulate polymers in an inventive composition is at least about 0.2% by weight. The content of porous, particulate polymers is preferably from about 0.5 to about 40% by weight, in particular from about 1 to about 30% by weight, or from about 2 to about 20% by weight, for example from about 3 to about 15% by weight, or from about 5 to about 10% by weight.

For the purposes of one preferred embodiment of the present invention, the content of hydrophilic compounds in an inventive composition is at least about 0.2% by weight. The content of hydrophilic compounds is preferably from about 0.5 to 40% by weight, in particular from about 1 to about 30% by weight, or from about 2 to about 20% by weight, for example from about 3 to about 15% by weight, or from about 5 to about 10% by weight.

For the purposes of another preferred embodiment, the ratio by weight of porous, particulate polymers to hydrophilic compounds is from about 1:10 to about 10:1, in particular from about 1:5 to about 5:1.

For the purposes of another preferred embodiment of the present invention, the ingredients of an inventive composition and their amounts used are selected in such a way that a film produced with the aid of an inventive composition has, immediately after the production process, a contact angle below 40° with respect to water, in particular below 30° C., below 20°, or below 100.

The contact angle here is measured using a DSA 10 Krüuss drop shape analyzer with the associated software. To this end, a droplet of volume 10 μl is applied to the appropriate surface, and a video recording is made of the movement of the droplet (max. 7 min). The contact angle of the droplet was determined from the video sequence as a function of time.

By way of example, an inventive composition has the following composition:
particulate polymers from 1 to 30% by weight
hydrophilic compounds from 1 to 30% by weight
solvents from 20 to 98% by weight
additives from 0 to 20% by weight.

In principle, it is possible to prepare an inventive composition in any desired manner, in particular via mixing of the compounds involved in the composition. For example, an inventive composition may be prepared by first dispersing the porous polymer particles in a solvent, for example in water, and then adding the other constituents of the composition to this dispersion. However, it is also possible to begin by preparing a dispersion or solution of any desired constituent of the composition, for example of the hydrophilic compound, in water, and then to add the polymer particles and, simultaneously or subsequently, other compounds envisaged in the composition.

The present invention therefore also provides a process for preparing an inventive composition in which an aqueous solution of a hydrophilic compound and an aqueous dispersion of a particulate polymer are mixed, or a water-soluble or water-dispersible hydrophilic compound is mixed with an aqueous dispersion of a particulate polymer, or a particulate polymer is dispersed in an aqueous solution of a hydrophilic compound.

Depending on the distribution equilibrium previously described above between hydrophilic compound and polymer particle, a portion of the hydrophilic compounds becomes adsorbed on or within the polymer particle, whereas another portion of the hydrophilic compounds remains in aqueous solution or dispersion. For the purposes of the inventive process it may, where appropriate, be necessary to begin by converting the polymer particles, as described above, to a condition which is “porous” in the sense of the present invention. To this end, the polymer particle is preferably pre-swollen in an appropriate solvent, such as water, before the addition of the hydrophilic compound takes place. However, in another possible method the hydrophilic compound and the polymer particle are introduced simultaneously into an appropriate solvent, and the swelling of the polymer particle is carried out in the presence of the hydrophilic compound.

For the purposes of another embodiment of the present invention, the inventive compositions are produced via a precipitation reaction. To this end, conditions A in which a polymer or a mixture composed of two or more polymers is soluble together with a water-soluble or water-dispersible hydrophilic compound or a mixture composed of two or more water-soluble or water-dispersible hydrophilic compounds are first used to prepare a solution comprising the polymer or the mixture composed of two or more polymers and comprising the water-soluble or water-dispersible hydrophilic compound or the mixture composed of two or more water-soluble or water-dispersible hydrophilic compounds.

The resultant solution is then exposed to conditions B under which the polymer or the mixture composed of two or more polymers is then insoluble, and precipitates as porous particulate polymer.

The principles applicable to the conditions A and B are that their selection has to be such that on transition from A to B the dissolved polymer precipitates to give a porous particulate polymer, or becomes converted in accordance with the abovementioned conditions, at least after a certain period under conditions B, to give a porous particulate polymer. The selection of the conditions has moreover to be such that on transition from A to B polymer particles are produced whose size corresponds to the abovementioned requirements.

The present invention therefore also provides a process for preparing an inventive composition in which, under conditions A in which a polymer or a mixture composed of two or more polymers is soluble, together with a water-soluble or water-dispersible hydrophilic compound or a mixture composed of two or more water-soluble or water-dispersible hydrophilic compounds, a solution is prepared, comprising the polymer or the mixture composed of two or more polymers, and comprising the water-soluble or water-dispersible hydrophilic compound or the mixture composed of two or more water-soluble or water-dispersible hydrophilic compounds, and the solution is then exposed to conditions B under which the polymer or the mixture composed of two or more polymers then has no solubility and precipitates as a particulate polymer.

For the purposes of another embodiment of the present invention, an inventive composition is prepared via an emulsion process. In this, a polymer insoluble in water is dissolved together with a hydrophilic compound of the abovementioned type in a solvent immiscible with water, and this solution is then emulsified in water, preferably in the presence of a surfactant acting as emulsifier. The solvent immiscible with water is then removed from the emulsion, for example by applying a vacuum. Removal of the solvent immiscible with water gives an inventive composition in which the polymer is present as particulate polymer. By way of example, the particle size may be adjusted in this process by way of the droplet size in the emulsion, which in turn may be adjusted via the selection of the nature of the emulsifier and its amount and the stirrer speed.

The present invention therefore also provides a process for preparing an inventive composition in which a solution of a hydrophilic compound and of a polymer in a solvent immiscible with water is emulsified in water to give an emulsion, and then the solvent immiscible with water is removed from the emulsion, thus giving a dispersion of a particulate polymer.

The transition from A to B therefore involves a change in the conditions under which the polymer is soluble. The inventive process is preferably carried out in such a way that the change from conditions A to conditions B includes at least one of the following alterations:
a) alteration of the pH
b) alteration of the solvent polarity
c) alteration of the temperature
d) alteration of the amount of solvent.

By way of example, a description of an appropriate process is given by R. Bodmeyer et al. in J. Micronencapsulation, 1991, Vol. 8, No. 2, 161-170, and the disclosure of this reference is expressly incorporated herein by way of reference, the disclosure of the cited text being regarded as part of the disclosure of the present text.

The inventive compositions are suitable for producing films on any desired surfaces.

The present invention therefore also provides a polymer film, produced from an inventive composition.

For the purposes of the present invention, a “polymer film” is a substantially continuous deposit on a surface. An inventive polymer film may be self-supporting, but a “polymer film” for the purposes of the present invention is generally a thin film which is not self-supporting, and which is located on a surface. The thickness of an inventive polymer film may be from about 10 nm to about 200 μm, in particular from about 50 nm to about 100 μm. An inventive polymer film preferably has a contact angle below 40° with respect to water, for example below 30° or below 20°. For the purposes of one preferred embodiment of the present invention, an inventive polymer film has a contact angle below 10° with respect to water.

An inventive polymer film may be produced by simple application of an inventive composition to a surface. The present invention therefore also provides a process for producing an inventive polymer film by applying an inventive composition to a surface, and filming the composition.

An inventive polymer film preferably comprises less than about 50% by weight of water, for example less than about 30% by weight.

In the inventive polymer film, the proportion of particulate polymers initially present in the composition used for producing an inventive polymer film is at least about 20% by weight, preferably at least about 30% by weight, or at least about 35% by weight.

The proportion of hydrophilic compounds is at least about 10% by weight, preferably at least about 20% by weight, or at least about 30% by weight.

The ratio of initially particulate polymer to hydrophilic compounds in the inventive polymer film is preferably from about 1:10 to about 10:1, in particular from about 1:5 to about 5:1, or from about 1:3 to about 3:1.

Examples are used below to provide further illustration of the invention.

### EXAMPLES

### Example 1

5% by weight of Dehypon LS 54 (producer: Cognis Deutschland GmbH) were added to a 10% strength by weight ethanolic solution of Eudragit® RS (polymethyl methacrylate-co-ammonioalkyl methacrylate), and were stirred until all of the material had dissolved. The resultant solution was introduced into three times the amount of water, whereupon the polymer precipitated in finely dispersed form. The median particle size was about 150 nm. The resultant dispersion was applied to a glass plate. Drying gave a transparent film. The contact angle on wetting of the film with water was below 10°, and remained constant even after a stream of water had been passed across the film for 2 minutes. Only after this period did the contact angle slowly increase.

### Example 2

5% by weight of Dehypon LS 54 (producer: Cognis Deutschland GmbH) were added to a 10% strength by weight ethanolic solution of Eudragit® RS (polymethyl methacrylate-co-ammonioalkyl methacrylate), and were stirred until all of the material had dissolved. The resultant solution was introduced into three times the amount of water, whereupon the polymer precipitated in finely dispersed form. The median particle size was about 350 nm. The resultant dispersion was applied to a glass plate. Drying gave a transparent film. The contact angle on wetting of the film with water was below 10°, and remained constant even after a stream of water had been passed across the film for 2 minutes. Only after this period did the contact angle slowly increase.

### Example 3

A commercially available CD preform was used as model substrate and was coated with a dispersion of example 1 via spray-application from a spray gun. After the layer had dried, a brush was used to paint coated preforms with ultramarine pigments and kaolin powder in the form of slurries. For comparative purposes, untreated CD preforms were likewise painted with the slurries mentioned. Without any other mechanical action, a stream of water was then passed across both the coated and the uncoated preforms for 1 min. After drying it was apparent that the soiling on the untreated substrates was almost unaltered, whereas the soiling on the coated substrates had been removed completely. The coating itself remained intact.

### Example 4

One half of a degreased pane of window glass was coated with a film composed of a composition of example 1 at a thickness of 0.2 μm, and the remaining half was left uncoated. The entire pane of window glass was then sprayed with a 0.1% strength dispersion of carbon black, dust, and skin grease. On the coated side of the glass sheet, there was found to be uniform wetting of the soiling dispersion and homogeneous run-off of the same. On the uncoated side, there was break-up of the wetting film, and isolated areas of liquid formed on the glass surface. Once the soiling dispersion had dried, a barely discernible haze caused by soiling was observed on the coated side, whereas a pronounced pattern of droplet margins and a greater overall amount of soiling was observed on the uncoated side.

### Example 5

An organic solution composed of 50 g of ethyl acetate, 0.05 g of n-decane, 1 g of cellulose acetate butyrate, and 0.5 g of Dehypon LS 24 was prepared, as was an aqueous solution composed of 100 g of deionized water and 0.02 g of SDS (Texapon K 12). The organic solution formed an initial charge, and the aqueous solution was slowly and progressively introduced, with stirring, using the action of an UltraTurrax (about 12 000 rpm). The dispersion process was then continued for about ten minutes. This gave a stable, milky-white O/W emulsion (demonstrated by conductivity measurement). The emulsion was then transferred to a round-bottomed flask, and the solvent was drawn off by slight heating and application of a vacuum. Complete removal of the ethyl acetate gave a stable, milky-white dispersion. The d50 particle size was 250 nm. The dispersion was capable of forming a film on glass, giving a coherent, slightly cloudy film. Directly after the application process, the film had a contact angle below 10° with respect to water.

1-11. (Canceled)

12. A surface coating composition, comprising:
a porous particulate polymer having a median particle size from 1 nm to 50 μm and water-solubility below 2 g/l at a temperature below 40° C. at a pH of from 5 to 8; and
a hydrophilic compound having a molecular weight below 1000.

13. The composition of claim 12, wherein the weight ratio of polymer to hydrophilic compound is from 1:10 to 10:1.

14. The composition of claim 12, wherein the hydrophilic compound is an anionic, nonionic, zwitterionic, ampholytic, or cationic surfactant.

15. The composition of claim 12, wherein the hydrophilic compound is an anionic surfactant comprising from 3% to 50% weight of the composition.

16. The composition of claim 12, wherein the median particle size of the polymer is from 10 nm to 30 μm.

17. The composition of claim 12, wherein the median particle size of the polymer is from 100 nm to 1 μlm.

18. The composition of claim 12, wherein the pH is from about 5.5 to about 7.

19. The composition of claim 12, wherein the water-solubility is below 0.5 g/l.

20. The composition of claim 12, wherein the water solubility is below about 0.1 g/l.

21. The composition of claim 12, wherein the polymer is:
a) an alginate, guar, xanthan carrageenan, cellulose ether, starch derivative, protein, polyacrylate, polymethacrylate, polyacrylamide, polymethacrylamide, polyurethane, polyester, polyamide, polyvinylprrolidone, vinyl polymer, or a copolymer thereof; or
b) comprised of monomers, which are monoethylenicaly unsaturated monomers having an acid group, ethylenically unsaturated sulfonic acid monomers, acrylamides, polyurethanes, acrylic acid, methacrylic acid, ethacrylic acid, alpha-chloroacrylic acid, alpha-cyanoacrylic acid, beta-methylacrylic acid, alpha-phenylacrylic acid, beta-acryloxypropionic acid, sorbic acid, alpha-chlorosorbic acid, 2′-methylisocrotonic acid, cinnamic acid, p-chlorocinnamic acid, beta-stearyl acid, itaconic acid, citraconic acid, mesaconic acid, glutaconic acid, aconitic acid, maleic acid, fumaric acid, tricarboxyethylene, maleic anhydride, sulfoethyl acrylate, sulfoethyl methacrylate, sulfopropyl acrylate, sulfopropyl methacrylate, 2-hydoxy-3-methacryloxypropylsulfonic acid, 2-acrylamido-2-methylpropanesulfonic acid, vinylphophoic acid, allylphosphonic acid, vinylbenzylphosphonic acid, acrylamidoalkylphosphonic acid, acrylamidoalkyldiphosphonic acid, phosphonomethylated vinylamines, acrylic derivatives of phosphonic acid, N-vinylamide, N-vinylformamide, N-vinylacetamide, N-vinyl-N-methylacetamide, N-vinyl-N-methylformamide, N-methylolacrylamide, vinylpyrrolidone, N,N-dimethylpropylacrylamide, dimethylacrylamide, diethylacrylamide, ethyl acrylate, methacrylic acrylate, butyl acrylate, butyl methacrylate, vinyl acetate, styrene, or isobutylene, or derivatives thereof.

22. The composition of claim 21, wherein the polymers are cross-linked with an amount of cross-linking agent that is below 7% by weight of total monomer.

23. The composition of claim 22, wherein the amount of cross-linking agent is from 0.1% to 0.5% by weight of total monomer.

24. The composition of claim 12, further comprising water.

25. The composition of claim 24, wherein water comprises at least about 10% weight of the composition.

26. The composition of claim 24, wherein water comprises at least about 20% weight of the composition.

27. The composition of claim 24, wherein water comprises at least about 50% weight of the composition.

28. A polymer film formed from the composition of claim 12.

29. The polymer film of claim 28, wherein the film has a contact angle below 40° with respect to water.

30. The polymer film of claim 28, wherein the film has a contact angle below 100.

31. A process for preparing a surface coating composition according to claim 24, comprising:
mixing a water-insoluble polymer with a hydrophilic compound in a solvent immiscible with water;
emulsifying the mixture in water; and
removing the solvent.
